(19) United States
(12) Patent Application Publication
(10) Pub. No.: US 2005/0053253 A1
(43) Pub. Date: Mar. 10, 2005

(54) Cone forward loudspeaker assembly

(76) Inventor: Frank Sterns, Miami, FL (US)

Correspondence Address: LOTT & FRIEDLAND, P.A., P.O. BOX 141098, CORAL GABLES, FL, 33114-1098, US

(21) Appl. No.: 10/656,615

(22) Filed: Sep. 5, 2003

(51) Int. Cl. H04R 1/02; H04R 1/20

(52) U.S. Cl. 381/345; 381/347; 381/354

(57) ABSTRACT

A loudspeaker assembly. This invention provides for a loud speaker assembly that rear-mounts a transducer so that the sound emanating from the transducer does not pass through a “tunnel” created by the thickness of the outer baffle surface or grille frame. In addition, the loudspeaker assembly can be provided with a natural appearing cabinet and can be used outdoors.

### FIELD OF INVENTION

This invention relates generally to loudspeakers and in particular to a loud speaker assembly or system whereby one or more transducers are mounted to the baffle such that the sound emanating from the transducer does not pass through a “tunnel” created by the thickness of the baffle or outer cabinet surface. In an alternate embodiment, the transducer can be mounted in a “cone forward” position when also being used in conjunction with a grille. The loudspeaker assembly of the present invention can be provided with a natural appearing cabinet and can be used outdoors.

### BACKGROUND OF THE INVENTION

The home audio industry places great emphasis on convenience, and sound quality. With the recent upward trend in home building, loudspeaker systems for the home are at the height of their popularity. In 2002, over 1.5 billion dollars worth of loudspeakers shipped throughout the United States. Consumer Electronics Survey, US. Census Department, http://www.census.gov/industry/1/ma334m02.pdf

Current loudspeaker assembly designs face a number of inherent difficulties. One difficulty is that loudspeaker designs today mount the transducers back from the surface of the speaker cabinet, this is both because the outer speaker cabinet surface has some inherent thickness and also because being slightly recessed improves the weather resistance of the sensitive transducer assembly. A loudspeaker designed in this fashion will inhibit the sound emanating from the transducers, thereby causing diffraction of the sound waves. In particular, the inner “wall” created by the thickness of the baffle the baffle, reflects sound emanating from the transducer. This reflection causes diffraction of the sound waves resulting in a megaphone-like reduced quality of sound reproduction.

Loudspeakers are available in many different configurations and are used in many different situations. For example, some loudspeakers are solely for indoor use, others outdoor. Many outdoor loudspeaker assemblies utilize cabinets that provide a natural appearance. Some of the most popular outdoor cabinets simulate rock surfaces. These rock-like loudspeaker assemblies are often used in conjunction with landscaping and are used to not only provide sound throughout an outdoor area but to also improve the area's appearance.

Previous attempts have been made to provide speakers that are useable outdoors and blend with their surroundings such as those described in U.S. Pat. No. 4,754,852 to Mulé et al. (the '852 patent); U.S. Pat. No. 4,082,159 to Petty (the '159 patent); and U.S. Pat. No. 4,063,387 to Mitchell (the '387 patent).

The '852 patent describes a simulated rock speaker cabinet in the form of a natural rock having build-up portions of modeling clay which include a pattern of small diameter holes to form speaker grills at longitudinally spaced positions. A chicken wire ring provides structural reinforcement to the speaker cabinet. The artificial rock cabinet may be molded of various hydrolytic cements, magnetite cement, a suitable catalytic plastic resin to which pigment or other colorants may be added along with glass or rock chips, to provide the simulated rock cabinet with an external appearance which corresponds to various natural rocks. The speaker cabinet has speakers and the various electronic components of the speaker system housed within the speaker cabinet and may be coated with water-proofing and weather-proofing material with the speakers molded into the wells and facing the grills. An end plug may be adhesively sealed to the opening within the base of the speaker cabinet and suitably sealed by Hydrostone or other cementious material.

The '159 patent describes a reflex type speaker enclosure, integrally formed of ceramic material having a shell of hemispheroidal configuration and having an intumed speaker mounting flange adjacent the equatorial plane. The enclosure is adapted to be suspended by structure extending through an aperture in its apex. The flange forms a central, relatively large speaker aperture, and a plurality of circumferentially spaced, relatively small acoustic ports intermediate the shell and aperture. The radially inner edge of the flange is notched at the speaker aperture to permit placement of a speaker assembly into the interior of the hemispheroidal shell and allow insertion of suitable fasteners therethrough to secure the speaker assembly to the inwardly facing side of the flange portion.

The '387 patent describes a hanging planter pot speaker enclosure for stereo or monaural music systems comprising a hollow ceramic housing enclosed on all sides and having openings at the top and bottom. A planter pot is set down into the top opening of the housing, and has a radially outwardly extending flange around its top edge that seats on the marginal edge of the top opening to support the pot, while at the same time forming a seal that closes the top opening. Mounted within the housing below the planter pot is a cone-type speaker that faces downwardly so that sound radiating from the speaker is projected downwardly through the bottom opening. The speaker is sealed to the inner wall of the housing around its entire periphery, so that the space within the housing between the speaker and the pot is entirely sealed. Air contained within this sealed space serves as a pneumatic spring, backing up the speaker cone to improve its response. Suspended below the bottom opening of the housing is a horizontal diffuser that deflects the sound from the speaker horizontally outward in all directions.

None of the devices mentioned above describe a loudspeaker assembly that provides a natural appearing cabinet usable indoors or outdoors, while also providing a cone forward design.

Therefore, there is a need in the art for a loudspeaker assembly that provides a cabinet that is operable in indoor or an outdoor environment.

There is a further need in the art for a loudspeaker assembly which is weather resistant.

There is still a further need in the art for a loudspeaker assembly that mounts the transducer in a “cone forward” position, for eliminating entirely or reducing sound distortion, even when used in conjunction with a grille.

### SUMMARY OF THE INVENTION

The present invention fulfills these needs by providing a loudspeaker assembly, comprising a loudspeaker baffle, the baffle being provided with at least one opening for audio wave output; and, at least one transducer mounted to the baffle such that the audio waves emanating from a mounted transducer avoid being distorted by the baffle.

In an alternate embodiment, the invention provided is an outdoor loudspeaker assembly, comprising a loudspeaker baffle, the baffle being provided with at least one opening for audio wave output; and, at least one transducer mounted to the baffle such that the audio waves emanating from the mounted transducer avoid being distorted by the baffle.

In another alternate embodiment, the invention provided is a loudspeaker assembly, comprising a loudspeaker cabinet, the cabinet being provided with at least one opening for audio wave output; a flange, the flange being recessed the same distance as the cabinet's surface thickness; and, at least one transducer mounted to the cabinet by the flange such that the audio waves emanating from a mounted transducer avoid being distorted by the cabinet.

In yet another alternate embodiment, the invention provided is a loudspeaker assembly, comprising a loudspeaker cabinet, the cabinet being provided with at least one opening for audio wave output; a flange, the flange being recessed the same distance as the cabinet's surface thickness; and, at least one transducer mounted to the cabinet by the flange such that the outermost point of the transducer is substantially flush with the cabinet's surface.

In another alternate embodiment, the invention provided is a loudspeaker assembly, comprising a loudspeaker baffle, the baffle being provided with at least one opening for audio wave output; a grille frame, whereby the frame provides an interface for attaching a grille to the baffle; a flange, attached to the baffle; and, at least one transducer mounted to the baffle by the flange such that the audio waves emanating from a mounted transducer avoid being distorted by the baffle and the frame.

Therefore, it is an object of the present invention to provide a loudspeaker assembly that provides a cabinet that is operable in indoor or an outdoor environment.

It is further object of the present invention to provide a loudspeaker assembly which is weather resistant.

It is an additional object of the present invention to provide a loudspeaker assembly that mounts the transducer in a “cone forward” position, for eliminating entirely or reducing sound distortion, even when used in conjunction with a grille.

These and other objects, features, and advantages of the present invention may be better understood and appreciated from the following detailed description of the embodiments thereof, selected for purposes of illustration and shown in the accompanying drawings.

### BRIEF DESCRIPTION OF THE DRAWINGS

FIG. 1 shows a prior art loudspeaker assembly that does not use a cone forward design.

FIG. 2 is a detailed view of the inherent disadvantage of a non-cone forward design in the prior art.

FIG. 3 is a cross sectional view of the present cone forward invention.

FIG. 4 is an illustrative view of various outdoor loudspeaker cabinet appearances.

FIG. 5 is a cross sectional view of the present cone forward invention when used in conjunction with a grille.

### DETAILED DESCRIPTION OF THE PREFERRED EMBODIMENT

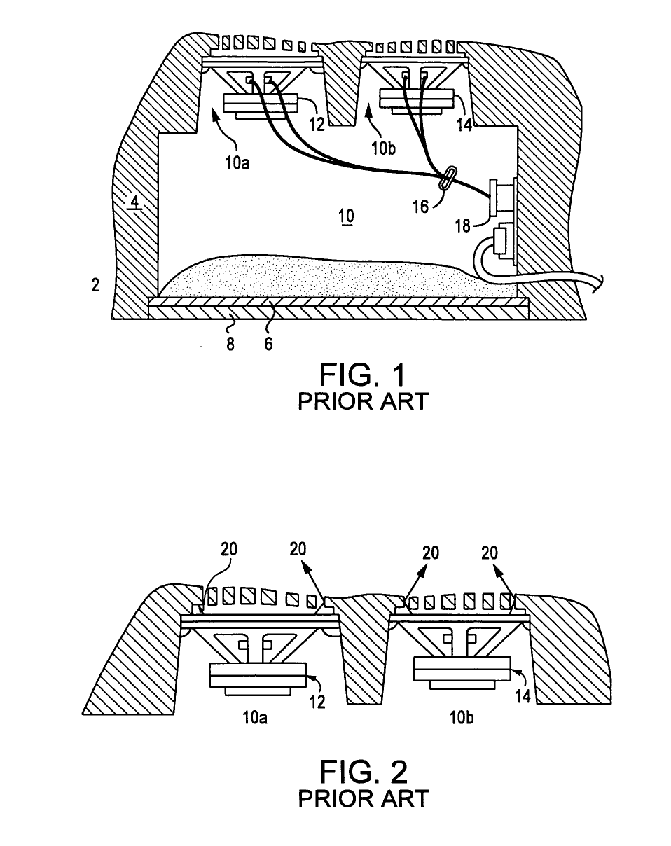

The loudspeaker assembly depicted in FIG. 1 is the invention of U.S. Pat. No. 4,754,852 to Mulé et al. The '852 patent is a simulated rock loudspeaker assembly 2 consisting primarily of the molded, hollow simulated stone cabinet or enclosure 4, having an opening 6 at the bottom of the cabinet or enclosure 4 closed by a formed cap or plug 8. The hollow cabinet 4 is formed with a relatively large cavity or chamber 10 which is characterized by longitudinally spaced, generally vertical cylindrical speaker wells 10a and 10b within which a first transducer 12 and a second transducer 14, are respectively mounted. The transducers are connected by leads 16 to a lower component or crossover 18. The internal leads 16 connect component 18 to respective transducers 12 and 14.

It can be seen from FIG. 1, and in more detail in FIG. 2, that the transducers 12 and 14 of the '852 patent are mounted below the outer lip of the speaker wells 10a and 10b provided for sound output. In today's loudspeaker assemblies, this is done to improve the weather resistance of the loudspeaker, and to protect the sensitive components of the transducer(s). However in this position, sound 20 produced by the transducers 12 and 14 is adversely impacted by the cabinet 4 wall, or rather, the thickness of the wall. The sound distortion created by the cabinet 4 wall imparts a megaphone-like quality to the audio output of the loudspeaker 2. It's the functional equivalent to someone yelling in a tunnel or cave.

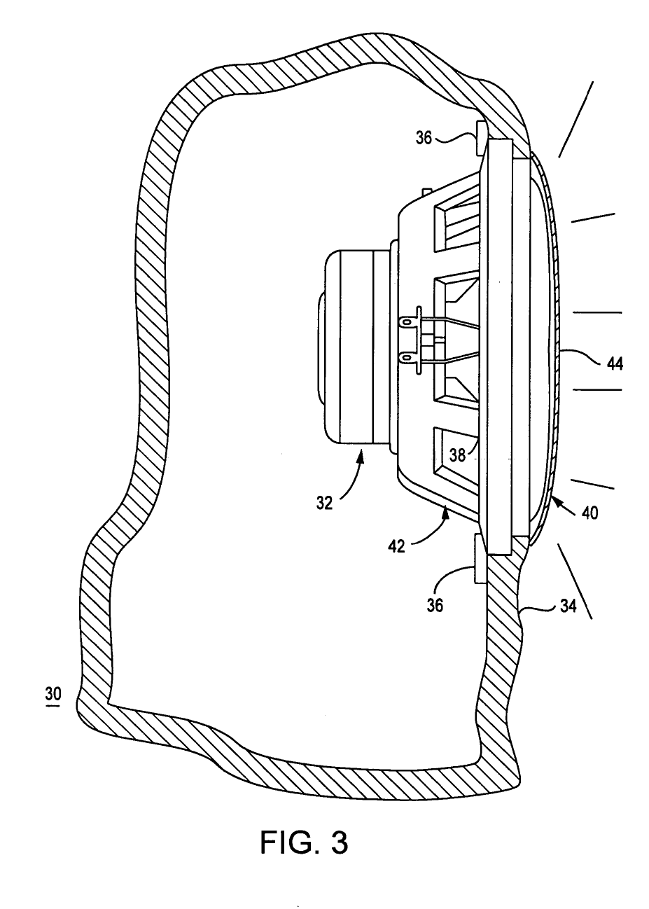

The present invention is designed to eliminate the megaphone-like effect produced by today's loudspeakers. Referring to FIG. 3, in the preferred embodiment of the present invention what is provided is a loudspeaker assembly 30 where the transducer 32 is positioned in such a way as to avoid sound distortion caused by the baffle 34. A mounting flange 36, which allows for the transducer 32 to be rear mounted, is recessed the same distance as the cabinet's 34 surface thickness, thereby moving the transducer cone 38 forward (hence the name “cone forward”) through the baffle opening 40 and eliminating the “megaphone” sound typically found in other rear mounted loudspeaker assemblies. The “cone forward” layout could be used with essentially any loudspeaker assembly. The ability to provide a cone forward position while being rear mounted avoids the need to rout out the baffle 34 in order to provide a place for the transducer 32 to sit. Furthermore, transducers mounted in baffles through routing suffer from weather sensitivities.

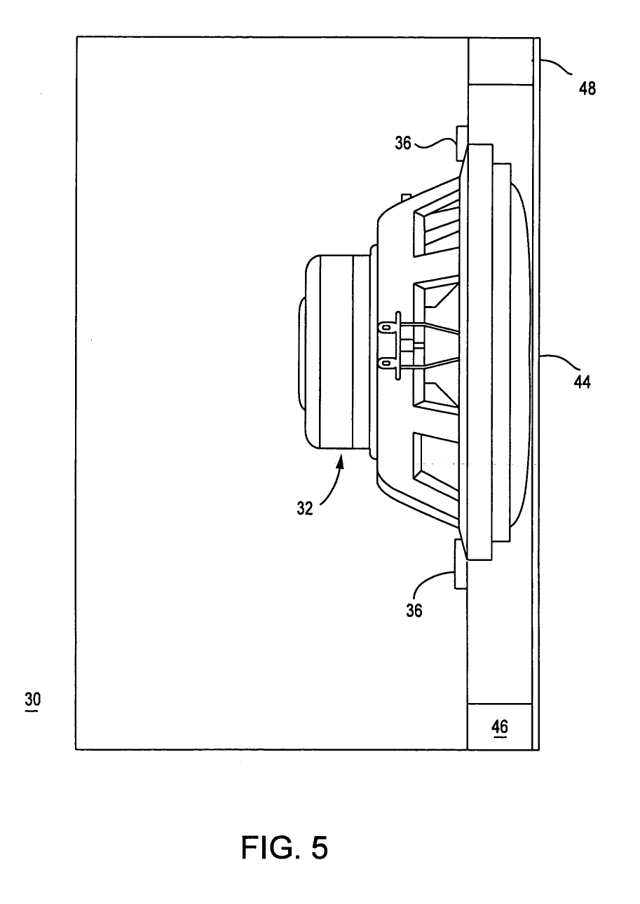

In addition to improving sound quality by moving the transducer 32 forward, the loudspeaker assembly's 30 weather resistance is also enhanced. Rear mounting the transducer 32 enables vital components to be behind the baffle 34 and also increases the effectiveness of weatherizing components, such as gaskets. The transducer 32 itself can be improved for weather resistance by replacing parts that are typically metal with plastic ones. As an example, the transducer frame 42 can be molded from plastic. A grille 44 for protection and for aesthetics may be added over the face of the transducer 32. FIG. 5 depicts a cone forward configuration for a loudspeaker assembly used in conjunction with a grille 44. It can be seen that grilles 44 are often attached to a grille frame 46, especially if the grille 44 is made of fabric. A cone forward loudspeaker assembly 30 which incorporates a grille 44 is constructed to ensure that the face of the transducer 32 is substantially even with the outer surface 48 of the grille frame 46.

It should be noted that more than one transducer can be utilized in the present invention and can encompass high, mid-range and low frequency transducers. Electric power and an audio signal are provided to the loudspeaker assembly 30 by means known to those skilled in the art.

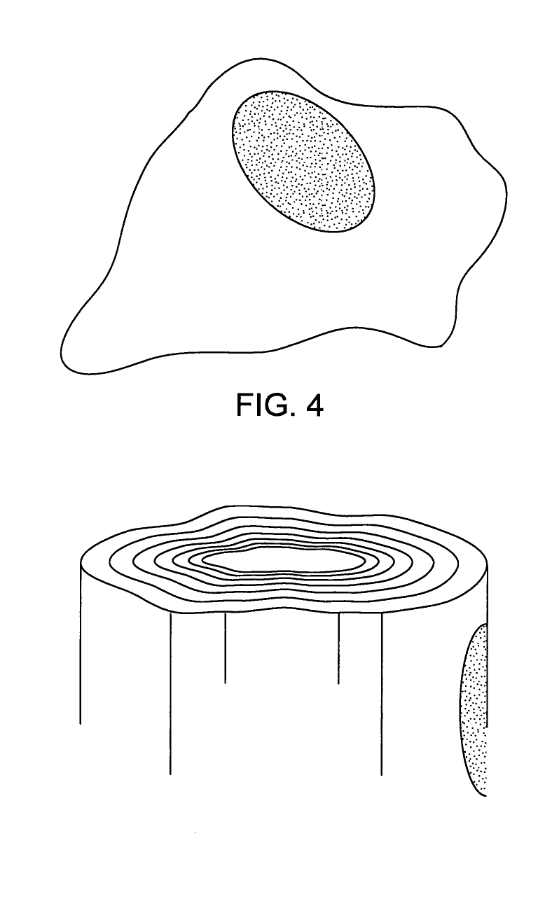

The “cone forward” loudspeaker assembly 30 of the present invention could be utilized for either indoor or outdoor use. The loudspeaker assembly 30 may be provided with a natural appearance in an alternative embodiment of the outdoor loudspeaker. For example, the assembly 30 could appear as a rock or as a tree stump. FIG. 4 depicts illustrative assembly 30 configurations.

Accordingly, it will be understood that the preferred embodiment of the present invention has been disclosed by way of example and that other modifications and alterations may occur to those skilled in the art without departing from the scope and spirit of the appended claims.

1. A loudspeaker assembly, comprising:
a loudspeaker baffle, said baffle being provided with at least one opening for audio wave output; and,
at least one transducer mounted to said baffle such that said audio waves emanating from a mounted transducer avoid being distorted by said baffle.

2. The loudspeaker assembly of claim 1, wherein said assembly is provided with a natural rock appearance.

3. The loudspeaker assembly of claim 1, wherein said assembly is provided with a natural wood appearance.

4. The loudspeaker assembly of claim 2, wherein said assembly is useable in an outdoor environment.

5. The loudspeaker assembly of claim 3, wherein said assembly is useable in an outdoor environment.

6. An outdoor loudspeaker assembly, comprising:
a loudspeaker baffle, said baffle being provided with at least one opening for audio wave output; and,
at least one transducer mounted to said baffle such that said audio waves emanating from a mounted transducer avoid being distorted by said baffle.

7. The outdoor loudspeaker assembly of claim 6, wherein said assembly is provided with a natural rock appearance.

8. The outdoor loudspeaker assembly of claim 6, wherein said assembly is provided with a natural wood appearance.

9. A loudspeaker assembly, comprising:
a loudspeaker baffle, said baffle being provided with at least one opening for audio wave output;
a flange, said flange being recessed the same distance as the baffle's surface thickness; and,
at least one transducer mounted to said baffle by said flange such that said audio waves emanating from a mounted transducer avoid being distorted by said baffle.

10. The loudspeaker assembly of claim 9, wherein said assembly is provided with a natural rock appearance.

11. The loudspeaker assembly of claim 9, wherein said assembly is provided with a natural wood appearance.

12. The loudspeaker assembly of claim 10, wherein said assembly is useable in an outdoor environment.

13. The loudspeaker assembly of claim 11, wherein said assembly is useable in an outdoor environment.

14. A loudspeaker assembly, comprising:
a loudspeaker baffle, said baffle being provided with at least one opening for audio wave output;
a flange, said flange being recessed the same distance as the baffle's surface thickness; and,
at least one transducer mounted to said baffle by said flange such that the outermost point of said transducer is substantially flush with said baffle's surface.

15. The loudspeaker assembly of claim 14, wherein said assembly is provided with a natural rock appearance.

16. The loudspeaker assembly of claim 14, wherein said assembly is provided with a natural wood appearance.

17. The loudspeaker assembly of claim 15, wherein said assembly is useable in an outdoor environment.

18. The loudspeaker assembly of claim 16, wherein said assembly is useable in an outdoor environment.

19. A loudspeaker assembly, comprising:
a loudspeaker baffle, said baffle being provided with at least one opening for audio wave output;
a grille frame, whereby said frame provides an interface for attaching a grille to said baffle;
a flange, attached to said baffle; and,
at least one transducer mounted to said baffle by said flange such that said audio waves emanating from a mounted transducer avoid being distorted by said baffle and said frame.

20. The loudspeaker assembly of claim 19, wherein said assembly is provided with a natural rock appearance.

21. The loudspeaker assembly of claim 19, wherein said assembly is provided with a natural wood appearance.

22. The loudspeaker assembly of claim 20, wherein said assembly is useable in an outdoor environment.

23. The loudspeaker assembly of claim 21, wherein said assembly is useable in an outdoor environment.
